(19) United States
(12) Patent Application Publication
(10) Pub. No.: US 2006/0196813 A1
(43) Pub. Date: Sep. 7, 2006

(54) Support beam for sieve panel

(75) Inventor: Rolf Kadel, Weinheim (DE)

Correspondence Address: THE FIRM OF KARL F ROSS, 5676 RIVERDALE AVENUE, PO BOX 900, RIVERDALE (BRONX), NY, 10471-0900, US

(73) Assignee: Ludwig Krieger Draht-und Kunststofferzeugnisse GmbH

(21) Appl. No.: 11/358,943

(22) Filed: Feb. 21, 2006

(30) Foreign Application Priority Data
Feb. 22, 2005 (DE) 102005007954.7

(51) Int. Cl. B07B 1/49

(52) U.S. Cl. 209/405; 209/412

(57) ABSTRACT

A support beam has a flat elongated metallic bar having a vertically oriented wide width dimension and a horizontally oriented narrow thickness dimension, and a mass of plastic substantially completely surrounding the bar and forming an upwardly directed face adapted to bear on and support a sieve-panel rim and an upwardly projecting formation interfitting with the rim. The bar in accordance with the invention is oriented centrally underneath the formation and the mass forms a pair of coplanar and adjacent support faces flanking the formation and each adapted to support a respective sieve-panel rim.

### FIELD OF THE INVENTION

The present invention relates to sieve. More particularly this invention concerns a support beam for a sieve panel.

### BACKGROUND OF THE INVENTION

A standard sieve has as described in German patent document 2,736,662 a plurality of normally planar and rectangular sieve panels having rigid and thick annular frames or rims in which are spanned sieve screens. The rims of such screen panels sit on a support rack comprised of an array of horizontal beams that are positioned so as each to engage the edge of two adjacent panels. In German '662 the beams are L-shaped and clip assemblies fitting through their horizontal flanges fit in edge moldings of the sieve panels to hold them down and in place.

In EP 0,167,999 the support beams are rectangular-section metal tubes having plastic cap moldings each formed with one or more downwardly extending rivets engaged through the top walls of the tubes and upwardly extending formations that hold down the panels. This structure is fairly complex and expensive to make, furthermore the metal parts of the elements are directly exposed to the particles passing through the mesh so they can get damaged or eroded rather quickly.

### OBJECTS OF THE INVENTION

It is therefore an object of the present invention to provide an improved support beam for a sieve panel.

Another object is the provision of such an improved support beam for a sieve panel that overcomes the above-given disadvantages, in particular that is inexpensive to manufacture yet that will have a long service life.

### SUMMARY OF THE INVENTION

A support beam has according to the invention a flat elongated metallic bar having a vertically oriented wide width dimension and a horizontally oriented narrow thickness dimension, and a mass of plastic substantially completely surrounding the bar and forming an upwardly directed face adapted to bear on and support a sieve-panel rim and an upwardly projecting formation interfitting with the rim. The bar in accordance with the invention is oriented centrally underneath the formation and the mass forms a pair of coplanar and adjacent support faces flanking the formation and each adapted to support a respective sieve-panel rim.

According to the invention the bar and mass are formed with aligned horizontally throughgoing mounting holes. In addition respective spacer washers flank and directly contact the bar at the holes. These washers have a thickness substantially equal to a thickness of adjacent regions of the plastic mass. The holes are formed at ends of the bar, and a frame element is bolted at the holes to the beam. Thus in spite of the protective plastic coating, the beam can be bolted solidly like a wholly metallic beam.

The plastic in accordance with the invention is polyurethane. Furthermore a second elongated metal bar fixed atop the first-mentioned metal bar has a wide horizontally oriented width dimension and a narrow vertically oriented thickness dimension. The first and second bars are fixed transversely together and together form a T-shape. The mass also substantially completely imbeds the second bar, which can according to the invention be unitary with the first bar. The terms length, width, and thickness are used here in their normal sense in that the length is the bar's greatest dimension, the width is its second greatest dimension measured perpendicular to its length, and the thickness is the smallest dimension measured perpendicular to both the length and the width.

The upwardly projecting formation is formed as an upwardly open hole that can be a slot or a succession of recesses. A retaining element engages downward in the hole and bears downward on the sieve-panel rim. This retaining element can be a plurality of rivet-like elements, or a continuous strip, depending on the construction of the retaining hole.

The beam is formed along a lower edge with downwardly open notches that prevent liquid from running along the beam. These notches are uniformly spaced along the beam.

### BRIEF DESCRIPTION OF THE DRAWING

The above and other objects, features, and advantages will become more readily apparent from the following description, reference being made to the accompanying drawing in which:

FIG. 1 is a side view of a beam according to the invention;

FIG. 2 is a cross section taken along line II-II of FIG. 1;

FIG. 3 is a large-scale view of FIG. 2, with some other sieve parts shown for explanatory purposes; and

FIG. 4 is a section like FIG. 3, taken along line IV-IV of FIG. 1.

### SPECIFIC DESCRIPTION

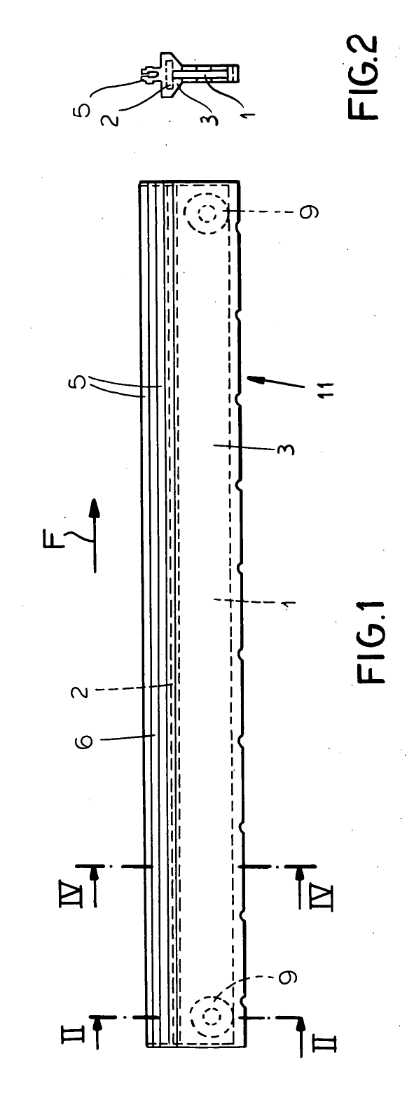

As seen in FIGS. 1 and 2, a sieve according to the invention has a plurality of horizontal beams 11 supporting edge frames 12 holding screens 13 of sieve panels 15. The beams 11 are normally formed into rectangular arrays holding a multiplicity of the panels 15, with the screens 13 all coplanar and two rims 12 sitting on each beam 11.

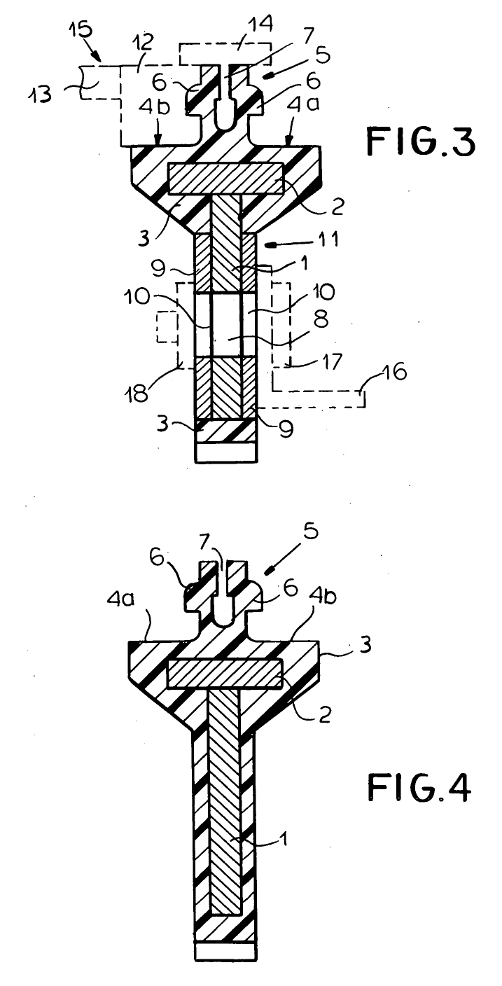

More particularly as better shown in FIGS. 3 and 4, each of the beams 11 comprises a first steel core bar 11 of rectangular shape with its relatively large width dimension oriented vertical, and its relatively small width dimension oriented horizontal, and a second steel core bar 2 welded atop the bar 1 and with its relatively large width dimension horizontal and its thickness dimension vertical, forming a T with the bar 1. This core 1, 2 is therefore very stiff both vertically and horizontally. It is completely surrounded by a thick layer 3 of polyurethane that increases the overall vertical and horizontal dimensions while still leaving the beam 11 generally T-shaped.

The layer 3 has an upwardly projecting retaining formation 5 that can be formed as a single ridge extending longitudinally, that is perpendicular to the plane of the view of FIGS. 2 and 3, or as a row of longitudinally spaced separate upward projections. The formation 15 forms a pair of outwardly projecting quarter-circular noses 6 that fit in the frames 12 to hold them down on horizontal and coplanar support faces 4a and 4b flanking the formation 6. In addition a center hole or slot 7 in the formation 5 holds a stem or leg of a retaining element 14 that bears down atop the frames 12 to secure them in place on the faces 4a and 4b.

As best seen by a comparison of FIGS. 1 and 3, the bar 1 is formed at least near each of its ends with a circular and transversely throughgoing hole 8. In addition secured to each of the vertically oriented horizontal side faces of the bar 1 at each of the holes 8 is a circular metallic washer 9 having an inside diameter identical to that of the hole 8 and a thickness equal to the thickness of the layer 3 of plastic surrounding the core 1, 2. Thus it is possible to secure the beams 11 very solidly through the aligned holes 10 and 8 of the washers 9 and bars 1 to a stationary angle-iron frame element 16 by passing a bolt 17 through a hole in the element 16 and the aligned holes 10 and 8 and then securing a nut 18 to the bolt 17.

I claim:

1. In combination with a sieve panel having a rim, a support beam comprising:
a flat elongated metallic bar having a vertically oriented wide width dimension and a horizontally oriented narrow thickness dimension; and
a mass of plastic substantially completely surrounding the bar and forming an upwardly directed face adapted to bear on and support the sieve-panel rim and an upwardly projecting formation interfitting with the rim.

2. The combination defined in claim 1 wherein the bar and mass are formed with aligned horizontally throughgoing mounting holes.

3. The combination defined in claim 2, further comprising
respective spacer washers flanking and directly contacting the bar at the holes.

4. The combination defined in claim 3 wherein the washers have a thickness substantially equal to a thickness of adjacent regions of the plastic mass.

5. The combination defined in claim 3 wherein the holes are formed at ends of the bar.

6. The combination defined in claim 3, further comprising a frame element bolted at the holes to the beam.

7. The combination defined in claim 1 wherein the plastic is polyurethane.

8. The combination defined in claim 1, further comprising
a second elongated metal bar fixed atop the first-mentioned metal bar and having a wide horizontally oriented width dimension and a narrow vertically oriented thickness dimension, the first and second bars being fixed transversely together and together forming a T-shape, the mass also substantially completely imbedding the second bar.

9. The combination defined in claim 1 wherein the upwardly projecting formation is formed with an upwardly open hole, the combination further comprising
a retaining element engaged downward in the hole and bearing downward on the sieve-panel rim.

10. The combination defined in claim 1 wherein the beam is formed along a lower edge with downwardly open notches.

11. The combination defined in claim 1 wherein the notches are uniformly spaced along the beam.

12. The combination defined in claim 1 wherein the bar is oriented centrally underneath the formation and the mass forms a pair of coplanar and adjacent support faces flanking the formation and each adapted to support a respective sieve-panel rim.
